(19) United States
(12) Patent Application Publication
(10) Pub. No.: US 2005/0034031 A1
(43) Pub. Date: Feb. 10, 2005

(54) Apparatus and method for detecting defective elements produced upon playing moving picture

(76) Inventor: Hyun-sung Gu, Gwacheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/795,311

(22) Filed: Mar. 9, 2004

(30) Foreign Application Priority Data
Aug. 7, 2003 (KR) 10-2003-0054664

(51) Int. Cl. G06F 11/00

(52) U.S. Cl. 714/48

(57) ABSTRACT

The present invention relates to the detection of noise produced upon playing a moving picture. An apparatus for detecting defective elements comprises a block setting unit which receives a moving picture signal and divides a moving picture corresponding to the signal into one or more blocks, a defective element determination unit which receives the blocked moving picture and determines the defective elements for each block, and an error frame information storage unit which stores information on a frame containing the defective elements detected by the defective element determination unit.

### BACKGROUND OF THE INVENTION

This application claims the priority of Korean Patent Application No. 10-2003-0054664 filed on Aug. 7, 2003 in the Korean Intellectual Property Office, the disclosure of which is incorporated herein in its entirety by reference.

1. Field of the Invention

The present invention relates to the detection of noise produced upon playing a moving picture, and more particularly, to an apparatus and method for automatically detecting errors such as mosaic or block noise produced when playing a moving picture.

2. Description of the Related Art

As technology for processing audio and video signals has progressed, a variety of audio and video formats have been proposed. Likewise, moving picture storage mediums, moving picture playing devices and the like using these formats have also been developed. Moving picture storage mediums include, but are not limited to, optical storage mediums such as a video compact disk (CD) or a digital video disk (DVD). Moving picture playing devices include DVD players, digital camcorders and the like. Digital camcorders use formats such as digital 8 mm, DV mode (digital 6 mm) and micro MV, while DVD players support MPEG2-PS format. These video formats are generally based on discrete cosine transform (DCT) which corresponds to a block structure image compression technique of 8*8 pixels. In the MPEG2 format, a macroblock structure of 16*16 pixels that is used in a time compression technique is additionally employed. In such a case, if an error such data loss is produced in the basic block of the DCT or the macroblock, mosaic or block noise (hereinafter, referred to as a “defective element”) is also produced.

Since it has been heretofore determined by the naked eye whether defective elements are produced, it has been difficult to accurately determine the occurrence of defective elements. Even though defective elements can be found with the naked eye, it is very difficult to accurately select the frame where the defective elements are produced. Therefore, there has heretofore been the necessity of ensuring the quality of the moving picture storage medium or the moving picture playing medium by automatically detecting whether the moving picture was stored in the moving picture storage medium without any defective elements or whether the moving picture playing medium can play a stored moving picture without generating defective elements in the moving picture. Such quality assurance is both time consuming and expensive.

### SUMMARY OF THE INVENTION

The present invention overcomes the aforementioned problems. Accordingly, an object of the present invention is to provide an apparatus and method for automatically detecting defective elements in a moving picture and additionally storing and providing information on the frame(s) where the defective elements are produced.

According to an aspect of the present invention, an apparatus for detecting defective elements in a moving picture comprises a block setting unit which receives a moving picture signal and divides a moving picture corresponding to the signal into one or more blocks, a defective element determination unit which receives the blocked moving picture and determines the defective elements for each block, and an error frame information storage unit which stores information on a frame containing the defective elements detected by the defective element determination unit. At this time, the moving picture signal may be a monochrome video signal.

Preferably, the block setting unit comprises an interface card capable of receiving two or more video signals.

Preferably, the defective element determination unit determines the defective elements using a rate of change in values of pixels located at the boundary of each block and pixel data distribution of the pixels within the block.

Preferably, the frame information is information on time(s) when the defective elements are produced, a positional coordinate of each block where the defective elements are produced, or information on an image file of the frame(s) where the defective elements are produced.

More preferably, the apparatus for detecting the defective elements further comprises an output unit for providing the moving picture frame(s) where the defective elements are produced in the form of a graphic user interface. Further, the graphic user interface can comprise a region on which a moving picture that is currently being played is represented and a region on which the time(s) when the defective elements have been detected is represented. Alternatively, the graphic user interface may further comprise a region on which an image corresponding to a time selected by a user is provided. At this time, the image is preferably an image in which a boundary line of each block where the defective elements are produced is represented in color.

According to another aspect of the present invention, there is provided a method of detecting defective elements, comprising the steps of (1) receiving a moving picture signal and dividing a moving picture corresponding to the signal into one or more blocks, (2) detecting the defective elements, if any, for each block, and (3) storing, when the defective elements are detected in step (2), information on each frame where the defective elements are produced. At this time, the moving picture signal is preferably a monochrome video signal.

Preferably, the step (2) comprises the step of determining the defective element using a rate of change in values of pixels located at the boundary of each block and pixel data distribution of the pixels within the block.

Preferably, the frame information is information on the time(s) when the defective elements are produced, a positional coordinate of each block where the defective elements are produced, or information on an image file of the frame(s) where the defective elements are produced.

More preferably, the method for detecting defective elements further comprises the step of providing the moving picture frame where the defective elements are produced in the form of a graphic user interface. In such a case, the graphic user interface can comprise a region on which a moving picture that is currently played is represented and a region on which time(s) when the defective elements have been detected is represented. Alternatively, the graphic user interface can further comprise a region on which an image corresponding to the time selected by a user is provided. At this time, the image is an image in which a boundary line of a block where a defective element(s) is produced is represented in color.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a view illustrating a product production line to which an embodiment of the present invention can be applied;

FIG. 2 is a block diagram of an inspection system that is arranged in the product production line of FIG. 1 to inspect the quality of a moving picture;

FIG. 3 is a block diagram of a hardware configuration of an apparatus for detecting defective elements according to an embodiment of the present invention;

FIG. 4 is a block diagram of another inspection system to which the defective element detecting apparatus according to an embodiment of the present invention can be applied;

FIG. 5 is a block diagram of an apparatus for detecting defective elements according to an embodiment of the present invention;

FIG. 6 is a block diagram of an apparatus for detecting defective elements in a moving picture using a plurality of received video signals according to another embodiment of the present invention;

FIG. 7 is a flowchart illustrating a method for detecting defective elements in a moving picture according to an embodiment of the present invention;

FIG. 8 is a flowchart illustrating a process of setting blocks during an initialization step of detecting defective elements according to an embodiment of the present invention;

FIG. 9 is a flowchart illustrating a process of inspecting the defective elements according to an embodiment of the present invention;

FIG. 10 is a flowchart illustrating a process of providing results of the inspection for the defective elements according to an embodiment of the present invention;

FIG. 11a is a view illustrating a graphic user interface for using a single received video signal to detect the defective elements according to an embodiment of the present invention;

FIG. 11b is a view illustrating a picture on which defective elements detected by the defective element detection apparatus according to an embodiment of the present invention are shown; and

FIG. 12 is a view illustrating a graphic user interface for using a plurality of received video signals to detect defective elements for each moving picture according to an embodiment of the present invention.

### DETAILED DESCRIPTION OF THE PREFERRED EMBODIMENTS

Hereinafter, an apparatus and method for detecting defective elements in a moving picture according to preferred embodiments of the present invention will be described in detail with reference to the accompanying drawings.

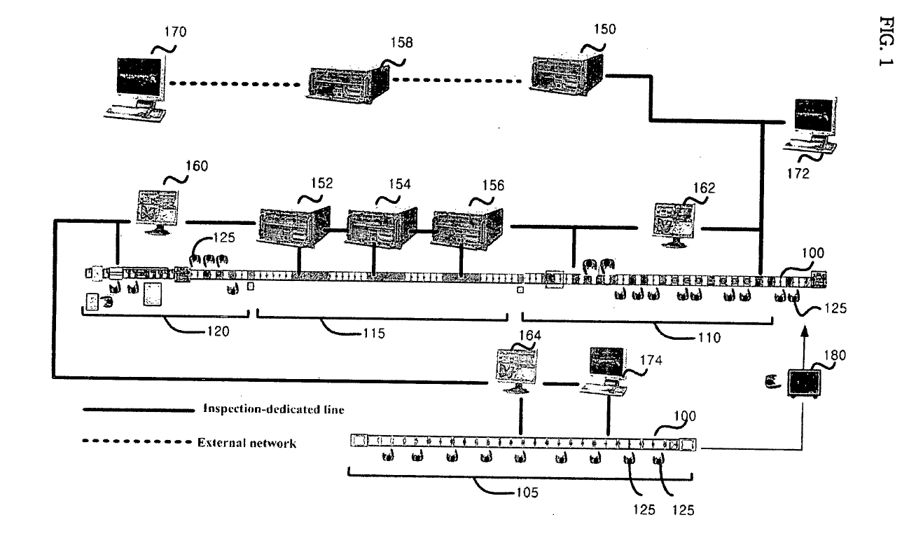

FIG. 1 is a view illustrating a product production line to which the present invention can be applied. More specifically, FIG. 1 shows a production line in which an apparatus capable of playing a moving picture (hereinafter, referred to as “moving picture playing apparatus”), such as a video cassette recorder (VCR) or a digital video disk (DVD) player, is manufactured.

The production line 100 is generally divided into four processes such as an assembly process 105, a finishing process 110, an inspection process 115 and a shipping process 120. Further, work manual providing devices 160, 162 and 164 for providing work manuals containing work information for workers (indicated generally at 125) in each process stage, inspection systems 152, 154 and 156 for inspecting moving pictures, monitoring terminals 172 and 174 for monitoring information on each process stage, and a server 150 for managing and providing a variety of information related to the production line 100 are connected through an inspection-dedicated line indicated by a solid line in FIG. 1. Meanwhile, the server 150 is connected to an external network in addition to the inspection-dedicated line, thus allowing a user to have access to the information related to the production line 100 through a monitoring terminal 170 from the outside. A test condition editing apparatus 158 for registering or updating the contents of test conditions for inspection of the moving picture is also connected to the external network. Alternatively, the test condition editing apparatus 158 may be disposed on the inspection-dedicated line.

Respective process stages of the production line 100 shown in FIG. 1 will be described in detail.

The assembly process 105 is a process of assembling components of a VCR or DVD player. After the components have been completely assembled, an assembled product is transferred to the finishing process 110 by means of a material trolley 180.

In the finishing process 110, a moving picture playing apparatus is finished using the assembled product and is supplied with electrical power to operate the finished apparatus. Then, a moving picture storage medium such as a videotape, DVD or video-CD is loaded into the apparatus to inspect the moving picture. At this time, the integrity of the moving picture storage medium is generally ensured.

The inspection process 115 is a process of inspecting whether the moving picture playing apparatus extracts data normally from the moving picture storage medium and provides the moving picture. This is the process to which the present invention can be applied.

In the shipping process 120, an apparatus from which no errors were found during the inspection process 115 is packaged and a box label is then attached thereto. An apparatus in which errors were found during the inspection process 115 can be separately collected and managed.

Information on the assembly process 105, the finishing process 110, the inspection process 115 and the shipping process 120 can be shared in the respective processes through the inspection-dedicated line indicated by the solid line in FIG. 1, and this information may be stored in the server 150.

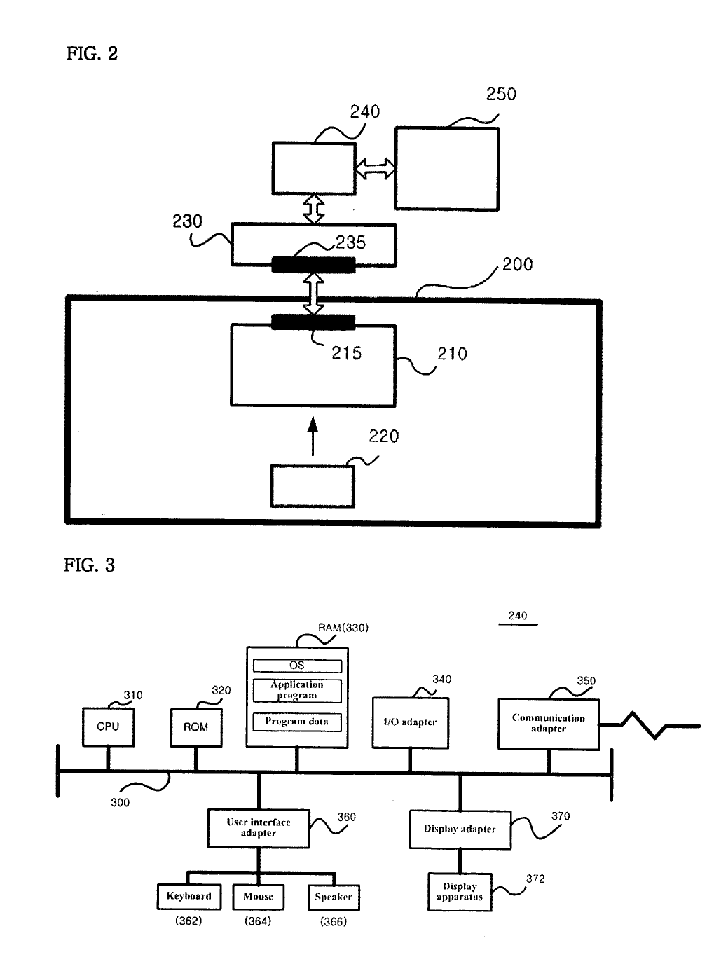

FIG. 2 is a view illustrating an inspection system for performing the inspection process 115 in the product production line of FIG. 1 for inspecting quality of the moving picture.

The inspection system preferably comprises a transport apparatus 200 such as a conveyer belt, a moving picture playing apparatus 210 having an output unit 215 for outputting audio/video signals, a control apparatus 220 for driving the moving picture playing apparatus 210, a signal distributor 230 having an interface unit 235 for receiving the audio/video signals from the output unit 215, a defective element detecting apparatus 240 for analyzing moving picture data received from the signal distributor 230 and inspecting the moving picture quality, and a display apparatus 250 for providing an inspector with inspection results.

The operation of the inspection system shown in FIG. 2 will now be described in detail.

If the moving picture playing apparatus 210 is moved by means of the transport apparatus 200, the control apparatus 220 causes the moving picture playing apparatus 210 to operate for the purpose of inspecting the moving picture quality. Herein, the control apparatus 220 can be a wireless remote control. In such a case, the wireless remote control may be directly manipulated by an inspector or automatically operated by setting, in advance, inspection items in the defective element detecting apparatus 240 and connecting the defective element detecting apparatus 240 to the wireless remote control. Alternatively, the inspection items can be first stored in the server 150 shown in FIG. 1 and then transferred to the inspection systems 152, 154 and 156.

When the moving picture playing apparatus 210 operates, moving picture data are read from the moving picture storage medium that was loaded in the previous stage and the audio and/or video signals are then output through the output unit 215. The output signals are collected in the signal distributor 230 through the interface unit 235. Although it is not shown in FIG. 2, the signal distributor 230 comprises two or more interface units 235 so that it can collect the audio and/or video signals from a plurality of moving picture playing apparatuses at once.

The signal distributor 230 transmits data for the collected signals to the defective element detecting apparatus 240. At this time, data communications can be implemented via a parallel interface or a high-speed serial interface such as IEEE1394.

The defective element detecting apparatus 240 analyzes the collected moving picture data and determines whether the moving picture playing apparatus 210 normally reads out the moving picture data. Further, the defective element detecting apparatus 240 provides the inspector with the current moving picture and the inspection results for the moving picture through the display apparatus 250 such as a monitor. In a case where the defective element detecting apparatus 240 inspects two or more moving picture playing apparatuses, the display apparatus can split a screen into two or more regions so that inspection results for each moving picture playing apparatus can be provided to the inspector. Herein, the signal distributor 230 or the display unit 250 may be incorporated into the defective element detecting apparatus 240.

Meanwhile, the inspection results collected by the defective element detecting apparatus 240 can be stored in the server 150 through the inspection-dedicated line indicated by the solid line of FIG. 1.

FIG. 3 is a view illustrating a hardware configuration of the defective element detecting apparatus 240 according to an embodiment of the present invention.

The defective element detecting apparatus 240 comprises at least one central processing unit 310 (hereinafter, referred to as “CPU”). The CPU 310 is coupled to system memories 320 and 330 and various kinds of other components through a system bus 300. The system bus 300 can be any of several types of bus structures including a memory bus or memory controller, a peripheral bus, and a local bus using any of a variety of bus architectures. By way of example, such bus architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PSI) that is also known as Mezzanie bus. Read only memory 320 (hereinafter, referred to as “ROM”) is connected to the system bus 300 and can be a basic input/output system (BIOS) for controlling all basic functions of the apparatus.

Further, FIG. 3 shows an I/O adapter 340 and a communication adapter 350 that are coupled to the system bus 300. The I/O the adapter 340 may be a Small Computer System Interface (SCSI) adapter for communicating with a hard disk or a tape storage device. The communication adapter 350 interconnects the external network and the system bus 300 to allow the defective element detecting apparatus to communicate with the other systems. A display apparatus 372 is connected to the system bus 300 through a display adapter 370 and can comprise a graphic adapter to improve the performance of a graphic intensive application and a video controller. In a preferred embodiment, the adapters 340, 350 and 370 can be connected to at least one I/O bus that is connected to the system bus 300 through an intermediate bus bridge (not shown).

A user interface adapter 360 connects input devices such as a keyboard 362, mouse 364, speaker 366 and the like to the system bus 300.

The defective element detecting apparatus 240 receives the moving picture data from the signal distributor 230 shown in FIG. 2 through the I/O adapter 340 or communication adapter 350. The received moving picture data are analyzed by an application program that is stored in RAM 330 to inspect the moving picture data. The moving picture that is currently being played can be provided to the inspector via the display adapter 370 and display apparatus 372.

Alternatively, information on the inspected moving picture can be stored in the hard disk via the I/O adapter 340 or stored in the server 150 through the inspection-dedicated line indicated by the solid line in FIG. 1 via the communication adapter 350.

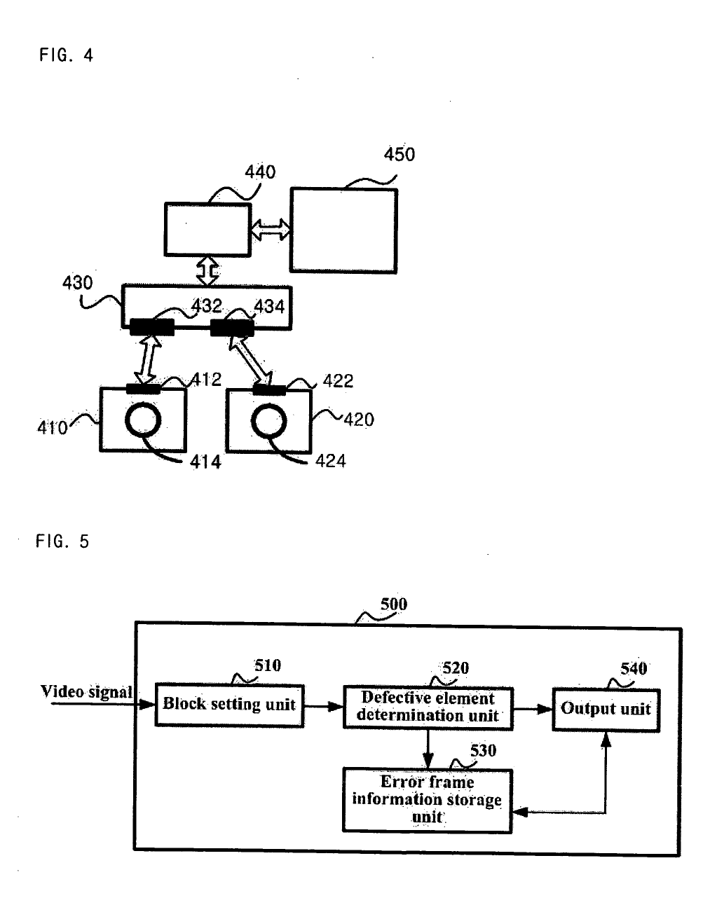

FIG. 4 is a view illustrating another inspection system to which the defective element detecting apparatus according to an embodiment of the present invention can be applied. FIG. 4 shows a system for playing a storage medium on which moving picture data are stored and then inspecting the quality of the storage medium. At this time, it is required that the integrity of the playing apparatus for playing the storage medium be ensured.

This inspection system comprises medium playing apparatuses 410 and 420 which play moving picture storage mediums 414 and 424 and having output units 412 and 422 for outputting audio/video signals, a signal distributor 430 having interface units 432 and 434 for receiving the audio/video signals from the output units 412 and 422, respectively, a defective element detecting apparatus 440 for analyzing moving picture data received from the signal distributor 430 and inspecting the moving picture quality, and a display apparatus 450 for providing an inspector with inspection results.

Two or more medium playing apparatuses 410 and 420 into which the moving picture storage mediums 414 and 424 are loaded can be operated automatically or directly by the inspector. When the medium playing apparatuses 410 and 420 operate, the audio/video signals are output through the output units 412 and 422. A process in which the output signals are processed through the signal distributor 430, the defective element detecting apparatus 440 and the display unit 450 is the same as the process illustrated in FIG. 2. Similarly, the signal distributor 430 and/or display unit 450 can be incorporated into the defective element detecting apparatus 440.

FIG. 5 is a block diagram of the apparatus for detecting defective elements in a moving picture according to an embodiment of the present invention. The apparatus 500 for detecting defective elements in a moving picture can be implemented in the form of the defective elements detecting apparatus 240 or 440 shown in FIG. 2 or 4, to which hardware, application programs, or a combination thereof is added.

The defective element detecting apparatus 500 comprises a block setting unit 510 for receiving video signals, dividing the received moving picture into predetermined blocks and then extracting pixel information of a block unit; a defective element determining unit 520 for comparing the pixel information for each block; an error frame information storage unit 530 for storing information on a frame in which one or more defective elements are produced, when it is determined that the defective elements are produced through the comparison of the pixel information in the defective element decision unit 520; and an output unit 540 for providing the inspector with comparison results obtained in the defective element decision unit 520.

The block setting unit 510 receives video signals obtained by extracting moving picture information included in a digital moving picture storage medium such as a DVD, or the video signals from output terminals of a variety of digital moving picture playing apparatuses such as a DVD player or a digital camcorder. When the block setting unit 510 sets a block corresponding to a video source, the defective element determination unit 520 determines whether defective elements exist in each block. The rate of change in values of pixels located at the boundary of each block and the pixel data distribution of the pixels in each block can be used so that the defective element determination unit 520 can determine if defective elements exist.

Meanwhile, when the defective element determination unit 520 finds any defective elements, the information on the frame where the defective elements are found is stored in the error frame information storage unit 530. Such information can contain time information on when the frame was played, image file information of the frame, the positional coordinate of any block where one or more defective elements are produced in the frame, and the like.

The output unit 540 displays the moving picture that is currently being played. At this time, to visually represent a block where any defective elements are produced, the interior of the error block can be indicated in black or the boundary of the error block can be indicated in a predetermined color so that it can be differentiated from adjacent blocks.

Moreover, the output unit 540 can provide frame information stored in the error frame information storage unit 530 in the form of a graphic user interface.

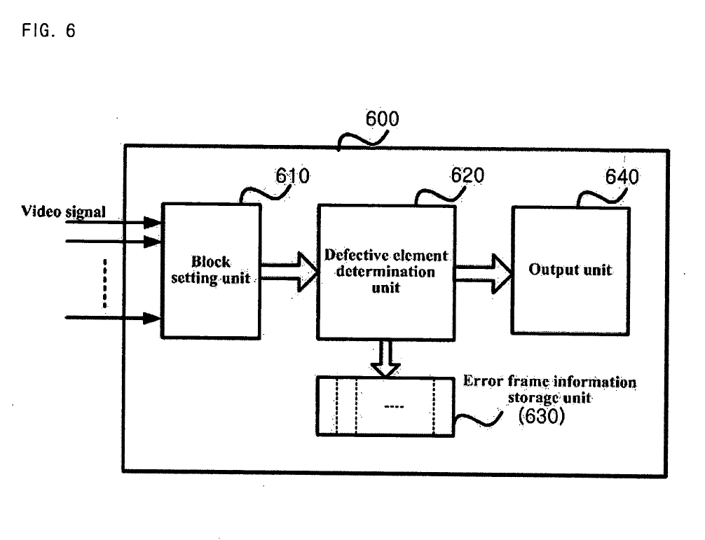

FIG. 6 is a block diagram of an apparatus for detecting defective elements in a moving picture using a plurality of received video signals according to another embodiment of the present invention.

A block setting unit 610 can receive one or more video signals as an input and determine defective elements for a plurality of video signals at one time. Herein, the block setting unit 610 comprises an interface card for inputting and outputting a plurality of video signals. Alternatively, a parallel interface card or IEEE1394 high-speed serial interface card can be used.

The operation of the apparatus shown in FIG. 6 is the same as that shown in FIG. 5. Alternatively, an error frame information storage unit 630 can divide error frame information storage spaces by the number of types of the video signals received by the block setting unit 610 and manage the divided spaces as a whole. Further, an output unit 640 can divide the moving picture displayed on the screen by the number of the video signals input to the block setting unit 610 and provide the divided moving picture.

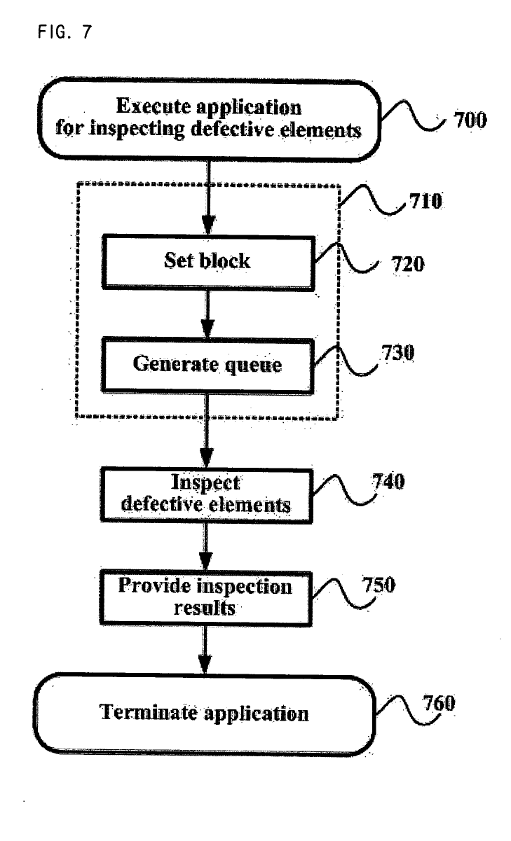

FIG. 7 is a flowchart illustrating a method of detecting defective elements in a moving picture according to an embodiment of the present invention.

When an inspector executes an application program for use in inspecting defective elements (700), a process 710 of initializing the program for the inspection is performed. The initialization process 710 comprises a process 720 of determining the size of block that is to be set in a frame to be inspected and a process 730 of generating a queue for temporarily storing the frames to extract frames in which any defective elements are produced.

After the fundamental settings required for inspecting defective elements in the program initialization process 710 have been completed, the process of inspecting defective elements is carried out (740). Whenever the inspection of frames containing defective elements is completed, the application program provides the inspector with the inspection results (750). Then, the process of inspecting the defective elements is terminated by the inspector's selection or end of the playing of the moving picture (760).

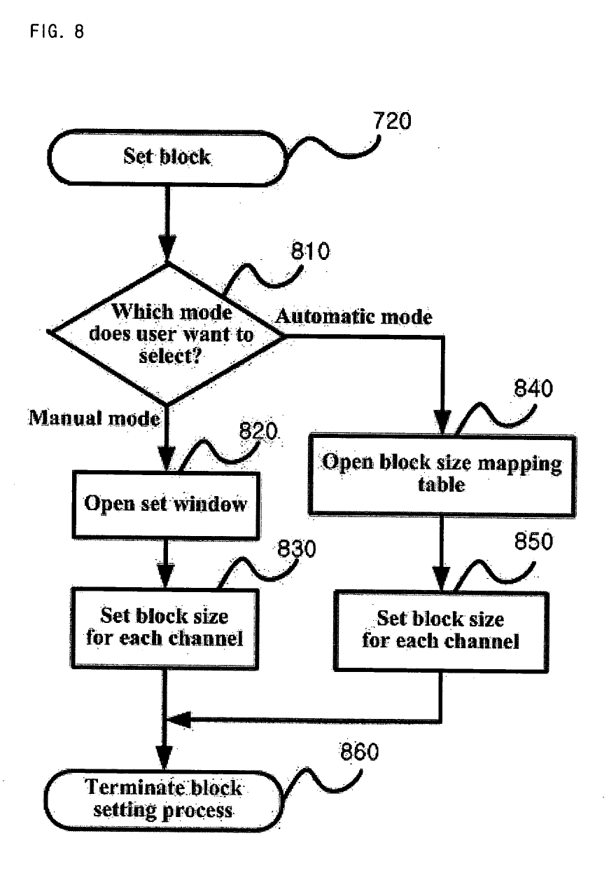

FIG. 8 is a flowchart illustrating the process of setting the block in the initialization process of the method for detecting the defective elements according to an embodiment of the present invention (i.e. 720 in FIG. 17).

The block setting process is divided into a manual mode in which blocks are set directly by the inspector and an automatic mode in which blocks are automatically set using a previously stored database.

In the case of manual mode, the application for use in the defective element detection process provides a predetermined means for setting a block. The setting means can be a menu provided in the application for the block setting or an additional window. When the block setting window is opened (820), the inspector determines and sets the block size for each channel according to identification information used to identify the moving picture playing apparatus or storage medium and whether to set the moving picture to be played in 8 by 8 pixel blocks or in 16 by 16 pixel blocks (830). In other words, as shown in FIG. 6, in a case where a plurality of moving picture signals are input, the size of block for each signal is determined.

On the other hand, in the case of automatic mode, a table into which block size and an object to be inspected are mapped is opened (840). At this time, the mapping table can be previously registered in the server 150 of FIG. 1 by the inspector and then loaded into the RAM 330 of the defective element detecting apparatus shown in FIG. 3. The mapping table contains identification information on the object to be inspected such as various kinds of storage mediums on which moving picture data are recorded, the DVD player or VCR and the like, and information on the block size of the moving picture corresponding to the identification information. Such identification information can be registered in advance in the server 150 by means of a barcode or i-button during the initial stage of the production line 100 shown in FIG. 1. When the mapping table is opened, the block size is automatically set for each channel (850) to which the moving picture signals are input. The block setting process can then be terminated (860).

Meanwhile, the mode setting 810 can be defined or updated in advance by the inspector.

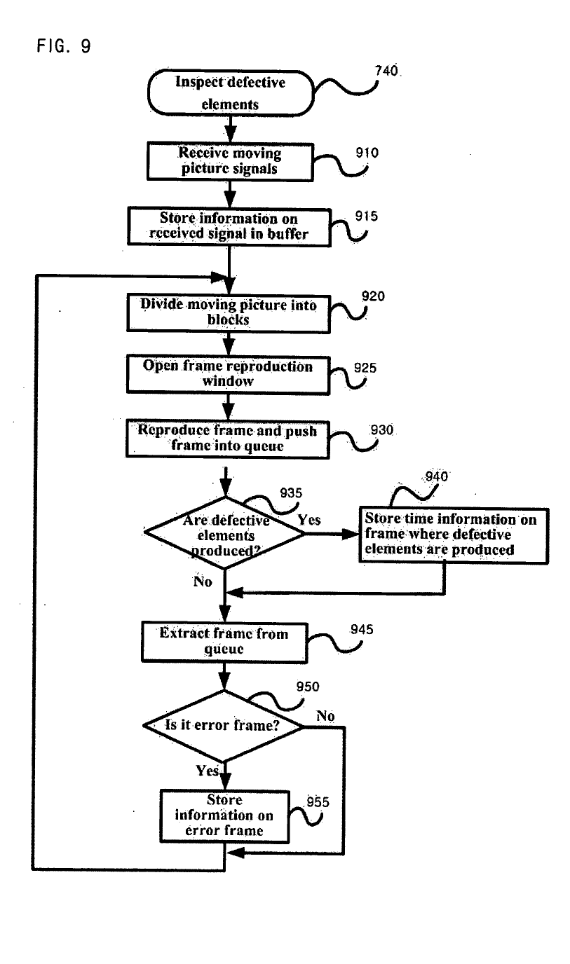

FIG. 9 is a flowchart illustrating a process of inspecting defective elements according to an embodiment of the present invention. After the program initialization process 710 has been completed, the defective elements are inspected (740).

When the defective element detecting apparatus receives moving picture signals (910), data information on the received signals is temporarily stored in a buffer (915). Herein, the buffer functions to coordinate the processing speed of the application for inspecting the defective elements and the receiving speed of the moving picture signals. The buffer is preferably located in the RAM 330 of the defective element detecting apparatus shown in FIG. 3. In a case where a plurality of moving picture signals are received, a plurality of buffers corresponding to the number of received signals can be used.

The application extracts the moving picture data from the buffer in a frame unit and then divides the extracted frame into blocks of the size that was previously set in the program initialization process 710 (920). Thereafter, the application opens the window for playing the frame and provides the inspector with the moving picture that is played (930).

The application stores each frame, which is played, in the queue generated in the program initialization process 710 (930). At this time, information on the frame can be stored in the queue. The frame information can include, but is not limited to, time information about when the frame was played, image file information of the frame, information on the block size of the frame, and the like. Further, in a case where a plurality of moving picture signals are input as shown in FIG. 6, a plurality of queues corresponding to the number of the received signals can be employed. The queues are preferably located in the RAM 330 of the defective element detecting apparatus shown in FIG. 3.

Next, the application determines whether defective elements have been produced in each frame (935). As for the frames in which defective elements have been detected, time information about when the frame was played is separately stored (940). The time information is synchronized with the time information that was already stored in the queue in step 930.

The application or a thread or child processor generated by the application sequentially extracts the frames from the queue (945). Since the frames containing the same time information as stored in step 940 are the frames containing defective elements, they are considered as error frames. In such a case, the frame information of the error frames is additionally stored (955). At this time, this frame information can become the frame information stored in the queue in step 930. After the defective element inspection for one frame has been completed, the next frame is extracted from the moving picture data information stored in the buffer in step 915 and steps 915 to 955 will be repeated for this frame.

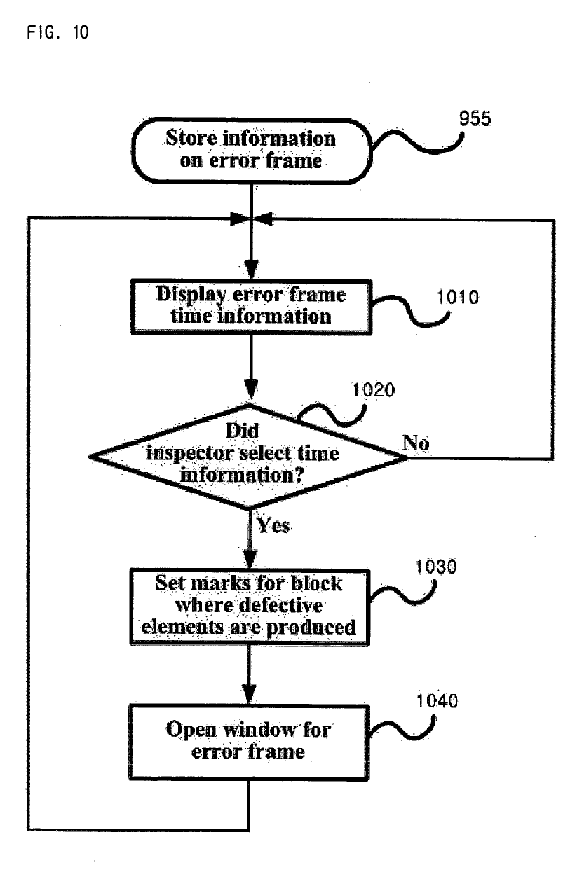

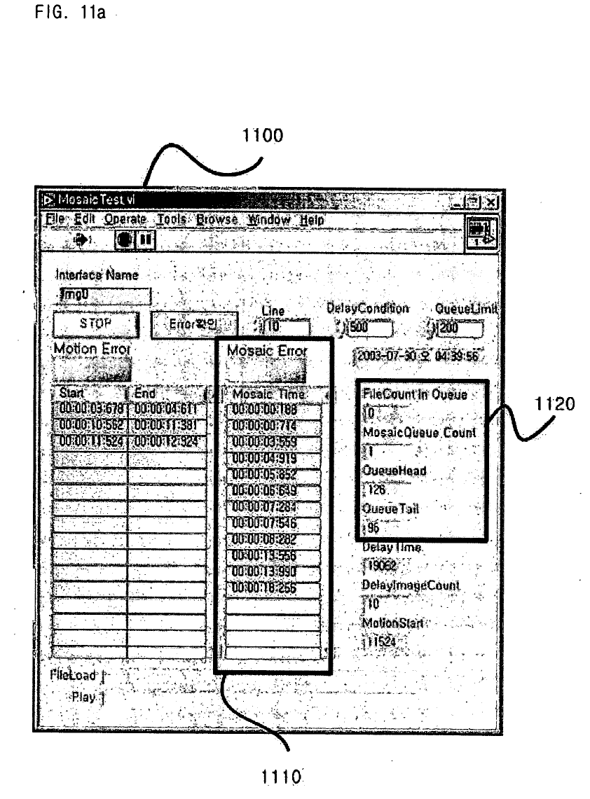

FIG. 10 is a flowchart illustrating a process of providing the results of the defective element inspection according to an embodiment of the present invention. The inspector can confirm the results of the defective element inspection using the error frame information stored in step 955.

The application for detecting the defective elements sequentially displays time information on the stored error frames in the form of a graphic user interface or text according to the playing time of the frames (1010). At this time, if the inspector selects this time information, a block where defective elements are produced is marked or represented so that the inspector can easily identify the block (1030). For example, the boundary of the block where defective elements are produced can be indicated by a solid colored line. The color of the solid line can be previously set or selected by the inspector through an additionally created window so that he/she can easily identify the relevant block. At this time, position information on the block where one or more of the defective elements are produced can be obtained using the block size information and the image file information among the error frame information. The position information can employ an x-y scalar coordinate or a vector coordinate.

If it is determined how to indicate the block where the defective elements are produced, the application creates an additional window and provides an image file for the error frame in which the block is indicated (1040).

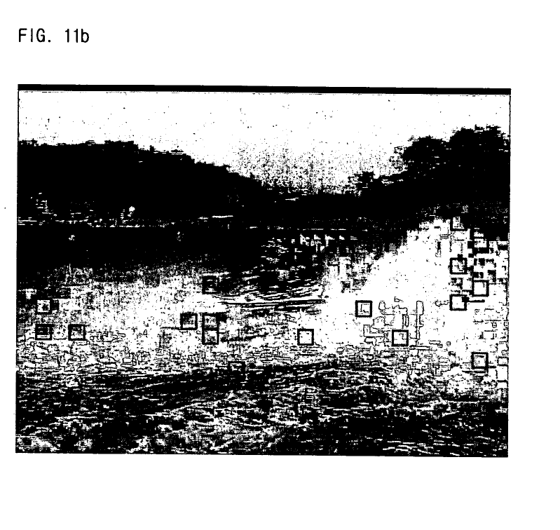

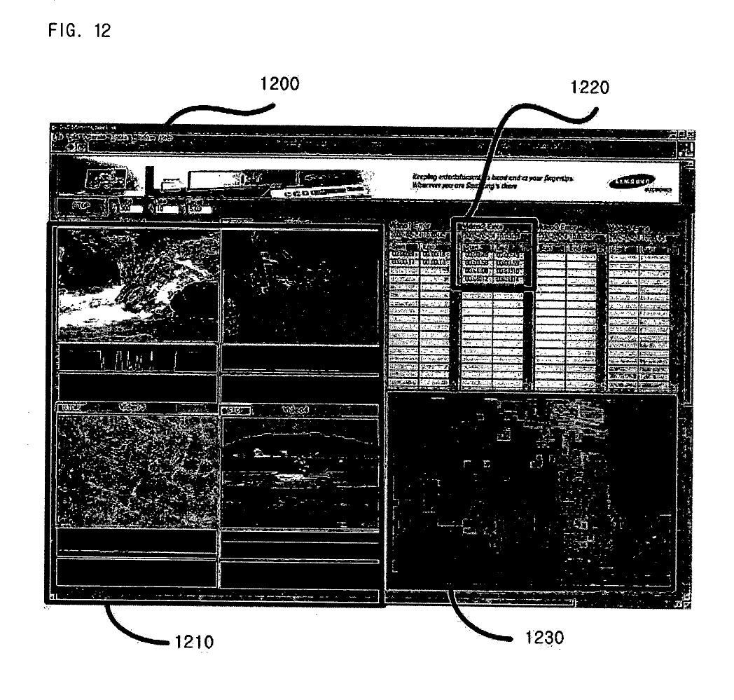

FIG. 11a is a view illustrating a graphic user interface 1100 for detecting defective elements using a single video signal according to an embodiment of the present invention.

The graphic user interface 1100 comprises a region 1110 on which a time when a frame containing one or more defective elements is played is represented, and a region 1120 on which information on the queue for temporarily storing the frame to extract the frame where defective elements are produced is represented.

Herein, the region 1110 indicative of the time information is implemented in step 1010 shown in FIG. 10. That is, when the inspector clicks any time information represented in the region 1110, the application that has executed the graphic user interface 1100 performs steps 1030 and 1040 of FIG. 10 to provide the inspector with an image file of the frame corresponding to clicked time information through an additionally created window as shown in FIG. 11b.

FIG. 12 is a view illustrating a graphic user interface 1200 for detecting defective elements for each moving picture using a plurality of video signals according to an embodiment of the present invention.

The graphic user interface 1200 comprises a region 1210 on which a moving picture that is currently being played is represented, a region 1220 on which time information on a frame where defective elements are produced is represented, and a region 1230 on which an image of the frame where defective elements are detected is represented.

As illustrated in FIG. 12, the moving pictures for all four video sources from video-1 to video-4 are shown in the region 1210 and the results of detecting defective elements for the four moving pictures are represented in the region 1220. That is, the time information region 1220 shows error start time and error end time of a frame where defective elements are produced as defective element detection results. The image region 1230 shows the image of the recently detected error frame. Similarly, when the inspector clicks any time information shown in the time information region 1220, the application that has executed the graphic user interface 1200 performs steps 1030 and 1040 of FIG. 10 to provide the inspector with the image file of the frame corresponding to clicked time information through the window as shown in FIG 11b.

According to the present invention as described above, the inspector can automatically confirm the defective elements in the moving picture by using the apparatus and method for detecting the defective elements produced when the moving picture is played. Further, the accuracy of the inspection results and reliability of the moving picture can be improved by additionally storing the information on the frame where defective elements are produced. Furthermore, there is an advantage in that the unmanned automatic inspection can be made.

While the present invention has been described in connection with the embodiments and the accompanying drawings, the present invention is not limited thereto since it will be apparent to those skilled in the art that various substitutions, modifications and changes may be made thereto without departing from the scope and spirit of the invention.

1. An apparatus for detecting defective elements in a moving picture, comprising:
a block setting unit which receives a moving picture signal and divides a moving picture corresponding to the signal into one or more blocks;
a defective element determination unit which receives the blocked moving picture and determines the defective elements for each block; and
an error frame information storage unit which stores information on a frame containing the defective elements detected by the defective element determination unit.

2. The apparatus as claimed in claim 1, wherein the moving picture signal is a monochrome video signal.

3. The apparatus as claimed in claim 1, wherein the block setting unit comprises an interface card capable of receiving two or more video signals.

4. The apparatus as claimed in claim 1, wherein the defective element determination unit determines the defective elements using a rate of change in values of pixels located at the boundary of each block and pixel data distribution of the pixels within the block.

5. The apparatus as claimed in claim 1, wherein the frame information is information on the times when the defective elements are produced.

6. The apparatus as claimed in claim 1, wherein the frame information is a positional coordinate of a block where a defective element is produced.

7. The apparatus as claimed in claim 1, wherein the frame information is information on an image file of at least one frame where a defective element is produced.

8. The apparatus as claimed in claim 1, further comprising an output unit for providing the moving picture frame where the defective elements are produced in the form of a graphic user interface.

9. The apparatus as claimed in claim 8, wherein the graphic user interface comprises a region on which a moving picture that is currently being played is represented and a region on which time when the defective elements have been detected is represented.

10. The apparatus as claimed in claim 9, wherein the graphic user interface further comprises a region on which an image corresponding to the time selected by a user is provided.

11. The apparatus as claimed in claim 10, wherein the image is an image in which a boundary line of a block where the defective elements are produced is represented in color.

12. A method of detecting defective elements in a moving picture, comprising the steps of:
(1) receiving a moving picture signal and dividing a moving picture corresponding to the signal into one or more blocks;
(2) detecting the defective elements, if any, for each block; and
(3) storing, when the defective elements are detected in step (2), information on a frame where the defective elements are produced.

13. The method as claimed in claim 12, wherein the moving picture signal is a monochrome video signal.

14. The method as claimed in claim 12, wherein step (2) comprises the step of determining the defective element using a rate of change in values of pixels located at the boundary of each block and pixel data distribution of the pixels within the block.

15. The method as claimed in claim 12, wherein the frame information is information on the time when the defective elements are produced.

16. The method as claimed in claim 12, wherein the frame information is a positional coordinate of the block where the defective elements are produced.

17. The method as claimed in claim 12, wherein the frame information is information on an image file of the frame where the defective elements are produced.

18. The method as claimed in claim 12, further comprising the step of providing the moving picture frame where the defective elements are produced in the form of a graphic user interface.

19. The method as claimed in claim 18, wherein the graphic user interface comprises a region on which a moving picture that is currently played is represented and a region on which times when the defective elements have been detected are represented.

20. The method as claimed in claim 19, wherein the graphic user interface further comprises a region on which an image corresponding to a time selected by a user is provided.

21. The method as claimed in claim 20, wherein the image is an image in which a boundary line of a block where the defective elements are produced is represented in color.

22. The method as claimed in claim 18, wherein the graphic user interface comprises a region on which moving pictures from respective ones of a plurality of input channels are represented, and a region on which respective times when defective elements have been detected in the input channels are represented.

23. The method as claimed in claim 12, wherein step (1) comprises the step of setting block size for an input channel according to identification information used to identify the moving picture playing apparatus or storage medium corresponding to the input channel.

24. The method as claimed in claim 23, wherein the moving picture playing apparatus is selected from the group consisting of a DVD player and a digital camcorder, and the storage medium is selected from the group consisting of a video compact disk (CD) and a digital video disk (DVD).

25. The method as claimed in claim 23, wherein the block size is set to one of 8 by 8 pixel blocks or 16 by 16 pixel blocks.

26. The method as claimed in claim 12, wherein step (1) comprises the step of setting block size in one of a manual mode and an automatic mode, the automatic mode employing a mapping table comprising identification information on the source of the moving picture signal such as various kinds of storage mediums on which moving picture data are recorded, a DVD player, or a VCR, and information on the block size of the moving picture corresponding to the identification information, the block size being automatically set for each channel to which the moving picture signals are input when the mapping table is opened.
